(19) United States
(12) Patent Application Publication
(10) Pub. No.: US 2004/0112217 A1
(43) Pub. Date: Jun. 17, 2004

(54) Use of napped textiles as a pollen filter

(76) Inventor: Andreas Schroder, Hamburg (DE)

Correspondence Address: Norris McLaughlin & Marcus, 30th Floor, 220 East 42nd Street, New York, NY, 10017, US

(21) Appl. No.: 10/468,868

(22) PCT Filed: Mar. 8, 2002
(86) PCT No.: PCT/EP02/02565

(30) Foreign Application Priority Data
Mar. 9, 2001 (DE) 101 11 308.0

(51) Int. Cl. B01D 46/00

(52) U.S. Cl. 95/273; 55/490; 55/528

(57) ABSTRACT

The use of a textile fabric which has at least one napped side for attachment in front of windows or doors to protect against dusty allergens such as pollen or house dust.

This invention relates to the use of napped textile fabrics as a protection system against the penetration of dusty, airborne allergens such as pollen and fungal spores into living and working areas by attachment in front of windows and doors over the whole area thereof.

The incidence of pollinosis (hay fever), ie the allergic reaction of the mucous membranes of the eye and of the upper and lower respiratory tracts with flower pollen and other airborne allergens, in the population has been monitored in Germany for a number of years. It was found for the last few years that about 11-15% of the population is affected. The allergic reaction of a pollen allergy usually manifests itself in reddening and lacrimation of the eyes (conjunctivitis), sneezing episodes (rhinitis) and a dry cough (bronchial asthma) as early reactions. Known late reactions to pollen allergy include for example neurodermatitis or eczema. As well as the personal symptoms of sufferers, there are more far-reaching consequences such as loss of earnings or work incapacity during the pollen season or increased medical treatment costs, so that there is an immense need for a gridlike pollen guard within the meaning of the invention for attachment in front of the windows and doors of living and working areas. Further information about pollinosis is available in Ratgeber Pollenallergie, Ute Künkele, Munich 1992.

Pollen allergies are triggered by the genes of wind-pollinated plants which, unlike insect-pollinated plants, utilize air movement to transfer their male genes. Pollens of wind-pollinated plants are for this reason generally smaller than those of insect-pollinated plants. Frequently occurring sizes are in the range from 15 to 50 μm. Familiar examples of wind-pollinated plants which trigger pollen-allergic reactions are birch, hazel, ragweed and a number of grass species.

Guard systems which are applied in front of windows and doors over the whole area thereof and which are intended to prevent the penetration of relatively large objects such as for example insects into living areas are known as flyscreens. DE 30 45 723 A1 describes for such a purpose for example curtains, nets, filters or sieves which are each applied to window or door frames by means of press studs. Owing to their relatively large mesh sizes of 1 to 2 mm, these do not possess an adequate protective effect against pollen dust.

Filtration means whereby air is freed of pollen, germs and spores find use for example in airconditioning and automobiles. The filtering effect is achieved in DE 39 04 623 A1 for example through the use of multi-ply filter mats formed from fleeces. To intensify the contact of the particle-laden air with the filter, the laminate of filter mats is additionally folded in a zigzag shape. The filtering effect against pollen is achieved by the fibrousness of the fleeces, since the interstices between the fibers are smaller than the pollen to be filtered.

A window guard against pollen, germs and spores is disclosed for example in DE 197 22 326 A1. A fleece is attached as a guard in front of the windowpane, not over the whole area thereof, but in the two wedgelike interstices and also the rectangular opening at the upper side of a window in tilt position.

A further way to filter pollen etc is proposed in DE 297 01 218 U. The filter is devised as a system to be attached in front of the window over the whole area thereof. The arrangement consists of a shrink film which is to be applied in front of the window and which in one area has a cutout into which a filter fleece is adhered by means of a doublesided adhesive tape.

A more developed form of a pollen filter is described in DE 198 56 490 A1. In this case, the filter consists of a fleece formed of polymeric fibers having an electrostatic activity and very fine pores to collect dust particles below 1 μm in size. The fleece in this example is additionally reinforced by a nonwoven scrim.

An example of the filtering of pollen and dust particles by wovens is illustrated in WO 94/09884 A1. The filtering effect in this case is achieved by a woven microfilament fabric where the filaments are spaced apart on the order of 30 μm.

Textile fabrics such as wovens, formed-loop knits and drawn-loop knits frequently offer advantages in mechanical stability over fleeces. Fleeces must for this reason be separately consolidated in the manufacturing operation. Another disadvantage with the use of fleeces is the less favorable air permeability and visual transparency for the same basis weight, for example on the order from 50 to 100 g/m². Moreover, fleeces often have abnormalities in transparency which are distributed over the fleece area and on account of which they have to be additionally finished by combing operations. The visual transparency issue has therefore been circumvented by some of the pollen guard systems described by their specific form of attachment to the window.

The approach of using a napped fabric textile to achieve a filtering effect against pollen is novel and to be protected.

Textile fabric refers to the totality of ways of producing textiles from yarn material by conventional fabric-forming operations such as drawn-loop knitting, formed-loop knitting or weaving without wishing to be bound by any one technique. The fundamentals of textile fabric-forming operations can be researched in Alfons Hofer: “Stoffe 2”, 1983, Deutsch Fachbuchverlag or “Kettwirkpraxis”, No. 4,1970, pages 19-20, Technologien der Kettwirkerei.

Textile fabrics are napped by a napping operation following the fabric-forming operation. Napping is generally accomplished by passing the textile web over teasels, which are usually realized as rolls equipped with sharp edges, such as blades or steel brushes. In napping, individual filaments of the yarn material are pulled out of the yarn and even severed, whereas the filament ends remain in the yarn. Further details can be found in Peter/Rouette: “Grundlagen der Textilveredlung”, Deutscher Fachbuchverlag Frankfurt, 1989.

Napped textiles are frequently used, on account of their pleasant sensory properties, for apparel purposes for example as front applique in the high-ticket outerwear sector, but they are also used as a plaster material. The use of napped textile fabrics as a pollen guard in front of window areas and door openings and also for other air inlets is a new field of application and is to be protected.

The use of a napped textile fabric has the advantage over the cited approach of achieving a filtration of pollen through the small distance between warp and fill threads in the case of woven fabrics that the filaments narrow the actual space between the threads through the napping operation and thereby create spacings between the filaments of two adjacent threads and/or the filaments of a single thread that are impassable for pollen. In addition, the raising of the filaments results in the two-dimensional fabric being extended into the third dimension. The raised filaments thus on the one hand, through a longer flow path, extend the contact time of the air with the filter material and on the other enlarge the filter surface area, which leads to improved filter properties.

This permits for example a higher air permeability which enables improved airing of the amenities, since the spacings of warp and fill threads do not have to be reduced to the diameter of the pollen to be filtered to achieve filtering.

It is an object of the proposed invention to indicate a woven or loop-formingly knitted fabric that can be used as a pollen guard in front of windows and doors over the whole area thereof.

This object is achieved as set forth in the main claim. The subclaims relate to advantageous refinements of the inventive concept.

The invention accordingly provides a textile fabric, preferably a loop-formingly knitted fabric, in which there is at least one napped surface.

The basis weight of the textile fabric is in the range from 30 to 200 g/m² and preferably between 40 and 100 g/m².

The filaments of the threads consist in particular of a polyester and are continuous filaments from 10 to 100 μm, preferably from 10 to 50 μm and more preferably from 10 to 25 μm in diameter.

The thread material is in particular from 50 to 500 μm and more preferably from 50 to 300 μm in diameter.

The textile fabric consists in particular of a multithread system.

The warp threads are in particular intermeshed in the form of a tricot construction according to DIN 53883 with a wale density from 50 to 500 and preferably from 100 to 300 and a course density from 100 to 600 and preferably from 150 to 300.

The structure of the warp threads is combined with further warp threads in the form of a closely set plain cloth construction.

The pollen guard system is useful not only for windows in households but also for roof lights and door openings such as balcony and patio doors and the like. The problem of the door being impassable can be solved through a specific design of the attachment system. A further use is in relation to car windows to allow someone who is allergic to pollen to open the window during the summer months.

The pollen guard system is attached to the outward grooves in the case of windows which pivot into the interior of the room and to the inward grooves in the case of windows which pivot outward.

Other embodiments for roof lights, as a permanent bed net or a simple-to-deinstall traveler's bed net form part of the inventive concept. Further embodiments of a pollen guard consist in a system to be attached to a perambulator and also as a bed net for cots, as a conventional curtain or in a pollen guard roller blind which is only unrolled in front of the window when needed. Additional embodiments of a pollen guard result from using the pollen guard in roof vents, as in buses for example.

A further embodiment of the pollen guard system consists in the manufacture of a wedgelike system which is fitted into the opening gap which appears when a tilt and turn window or door is tilted open. In addition, the pollen guard can be configured in such a way that in the case of pivoting wing windows, whose wings swing open on two horizontal central pivots, it may likewise be fitted in the resulting opening slots.

Further embodiments of the pollen guard are the impositioning of the filter according to the present invention in a cutout in a foil or some other material by means of customary attachment techniques, for example for cost reasons or for framing, which is subsequently attached in front of the airing means, such as a window, to be covered. The present invention likewise comprises covering the pollen guard with a protector against mechanical stresses such as for example with a grid or a coarsely meshed woven fabric or the like.

The invention further encompasses the use of the filter material in airconditioning means such as for example in the airing system for buildings, caravans or motor vehicles, including as a filter inset in window frame material or even in a glass window pane itself. Further embodiments are in the leisure sector such as for example the use in tents or in front of boat cabin doors.

An additional embodiment is constituted by the use of the filter material as a hood to protect the head or as means to protect the face, eyes, mouth or nose.

Some attachment systems according to the present invention will now be more particularly described with reference to the example of attaching the pollen guard to windows without wishing to restrict the possible forms of attachment to this embodiment.

The mounting of the pollen guard system can be carried out in various ways. An example of an advantageous way is to attach it by means of a onesided adhesive mushroom tape. To this end, the mushroom tape is adhered into the groove of the window so that it frames the window opening to be fitted with the pollen guard system. The pollen guard formed-loop knit, after it has been trimmed to the size of the window, is pressed onto the mushroom tape and held in place by the mushrooms.

Instead of a mushroom tape it is similarly possible to use a hook and loop tape in a further embodiment.

A further way to attach the pollen guard system is to use an additional mushroom tape which possesses a felty fabric. After the window frame has been equipped with the adhesive mushroom tape, the further mushroom tape is applied with the fleece side to the adhered mushroom tape, followed by the application of the pollen guard formed-loop knit. The advantage of using an additional mushroom tape is the easier demounting and remounting of the pollen guard for example at the end and on recommencement of the pollen season. Since the pollen guard formed-loop knit is individually cut to size by the user, it is additionally necessary for the loop-formingly knitted structure to be protected against damage to the loop-formingly knitted structure such as for example the inadvertent pulling out of the fill threads. The attaching of the fleece mushroom tape can provide a similar protective effect at the pollen guard formed-loop knit such as that of a seam. To apply the pollen guard loop-formed knit to doors, moreover, there is the advantage that the pollen guard formed-loop knit equipped with the fleece mushroom tape can be rolled up along the door groove in the applied state to enable passage through the door without the system having to be completely removed. Another conceivable way to make passage through the door possible is a vertical slot in the formed-loop knit that can be closed by means of a similarly constructed fleece mushroom tape system.

A further embodiment of the attachment system consists in the use of adhesive materials such as for example onesided or doublesided adhesive tapes, varieties of other double-sided adhesive materials such as tesa® Power Strips or the adhering of the pollen guard by means of an adhesive only. Additional embodiments are constituted by the attaching of the pollen guard by means of nails, tacks, hooks, screws, bolts, clamps, buttons, press studs, paperclips or with the aid of a curtain rail. It is also conceivable to attach the pollen guard system via auxiliary struts which are situated in a seam at the edge of the pollen guard or secured thereto in some other way and which are fixed in clamping means attached to the frame of the window.

### EXAMPLE

The example which follows compares the filtering effect with regard to birch pollen of unnapped with napped knit at even lower stitch density without wishing to restrict the invention to the example mentioned. The methods of measurement used are also described.

a) Comparison of Filtration Effect of Napped with Unnapped Surface

| Formed-loop knit 1: | |
|---|---|
| Manufacturer: | Mattes & Ammann |
| Sample number: | 30961 |
| Material: | Polyester |
| Structure: | Pillar stitch lapping with nontextured |
| | fill threads in partial insertion |
| | Nontextured fill thread inlaid into the |
| | pillar stitches zigzaggedly joins |
| | together two pillar stitches which |
| | are separated by one pillar stitch |
| Stitch density: | 39200 |
| Basis weight: | 85 g/m² |
| Filter effect v birch pollen F: | 3% |
| Formed-loop knit 2: | |
| Manufacturer: | Mattes & Ammann |
| Sample number: | 30608 |
| Material: | Polyester |
| Structure: | Combined plain cloth/tricot construction |
| Basis weight: | 55 g/m² |
| Stitch density: | 35 800 |
| Filter effect v birch pollen F: | 40% |

Comparison of the results for the filtration effect versus birch pollen shows for formed-loop knit 2 even at lower stitch density clearly the filtration-supporting effect of the napped knit within the meaning of the invention to be protected.

b) Description of Methods of Measurement Used

Determination of Basis Weight

The values reported in the table are manufacturer data.

Determination of stitch density was determined according to DIN 53883. The measuring apparatus used was a Leica WILD M3Z stereomicroscope with associated line scale having a scale division value of 1 mm.

Determination of Filtration Effect with Regard to Birch Pollen

The principle of measurement is based on a simultaneous particle count by means of two particle counters.

Birch pollen is atomized and introduced into an air flow through a tubular experimental setup by means of compressed air. The intake funnels of two commercially available particle counters, one of which is covered with the test pattern, while the other is left uncovered for reference, are situated at the point of exit from the housing. The particle counters simultaneously provide particle counts per measurement for the uncovered case and for the case covered with the test pattern. The two measured values can be used to calculate an individual value E for the filter effect of the sample:

$$E = 100 \% \times ( 1 - \frac{{particle\_count}_{covered funnel}}{particle {count}_{uncovered funnel}} )$$

The filter effect with regard to birch pollen F reported in the examples is the result of ten individual measurements, owing to the very high standard deviation of the individual values. By alternating the intake funnel which is to be covered with the test pattern it is possible to dispense with the determination of the apparatus constant, which arises from incompletely homogeneous distribution of the pollen in the air flow and apparatus differences in the particle counters. The comparison limit of this method is 10%; that is, differences above 10% in the filter effect of the two samples are significant. Since the two particle counters also capture particles present in the indoor air, but it is not known how many indoor air particles are filtered, no correction was applied to the individual values. It can be estimated that, when the two measured values are diminished by the number of indoor air particles, the result for the individual value of the filter effect is higher better.

The experimental setup consists of a tubular housing. At the point of air inlet is situated a blower to adjust the air flow through the tubular housing, this blower aspirating ambient air and conveying it through the housing. The intake funnels for the particle counters and also the cup wheel of an anemometer are situated at the air outlet. The birch pollen is introduced on the suction side of the blower.

The tubular experimental setup is 1.6 m in length and 0.29 m in diameter for the circular cross section. The tube walls consist of aluminum sheet 1 mm in thickness.

The air flow is realized by a blower which is sealingly attached to the housing inlet and which can continuously generate wind speeds of up to 5 m/s via closed loop control means. The diameter of the blower is flush with the diameter of the housing. This experimental apparatus was equipped with a Ziehl EBM ball bearing fan having a high air volume rate.

The intake funnels for the particle counters and the cup wheel of the anemometer are mounted on the outermost radius of the exit opening from the housing and protrude into the exit housing by 3 to 4 cm. The intake funnels and the cup wheel are aligned parallel to the air flow. The exact positions of the intake funnels and of the cup wheel are illustrated with reference to the face of a timepiece. Viewed in the direction of flow, the intake funnels occupy the positions at 5:30 and 6:30 while the cup wheel is positioned at 7 o'clock.

The particle counters used are a Partoscope R from Kratel and a 28DD particle monitor from Deha. Both instruments possess plural measuring channels for various particle size ranges. As a result, particle size ranges from above 0.3 to above 5 μm can be determined distributively and cumulatively for the Partoscope R counter and particle size ranges from about 0.3 to above 10 μm can be determined distributively and cumulatively for the 28DD counter. The measured values utilized for determining the filter effect constitute the particle numbers measured cumulatively for the range above 3 μm for both particle counters. The measuring time to determine the reference and comparative values was 60 s for both instruments.

The air speed was measured using a mini air-IV anemometer from Schiltknecht Ing. The results of the tests were obtained at a wind speed of 3 m/s.

The test substance used was natural birch pollen. Birch pollen has a size spectrum from about 10 μm to 30 μm in diameter and is approximately spherical. Birch pollen for medical purposes is available from Allergon of Sweden. The measured results were generated with the birch pollen species Betula lutea.

The birch pollen was introduced into the air stream by using compressed air to blow it out of a stock reservoir vessel, through a hose system and perpendicularly and centrally upstream of the suction side of the blower. To this end, about 0.001 g of birch pollen is weighed into a 100 ml ground joint conical flask used as a stock reservoir vessel. The conical flask is sealed with a gas inlet tube having a ground joint fitting that of the conical flask and an outlet opening.

The compressed air supply is connected up to a three-way cock by means of a hose. The other two terminals of the three-way cock are connected via hoses to volume flow measuring means and to the inlet opening of the gas inlet tube in the conical flask. The outlet opening of the stock reservoir vessel is connected through a hose to a glass tube which is situated centrally and perpendicularly, directly above the suction side of the blower.

The setting of the three-way cock determines whether the compressed air volume flow is measured or the compressed air is passed through the stock reservoir vessel to atomize the pollen. The measured results were obtained with the compressed air volume flow set to 15 l/min. To introduce pollen into the system, compressed air was passed through the stock reservoir vessel for 5 s during the abovementioned measuring time of 1 minute.

The samples were attached in front of the intake funnels of the particle counters by adhering an approximately circularly round sample about 4.5 cm in diameter to a matching circularly round frame. The frame has been appropriately equipped with a doublesided adhesive tape. The adhesive tape used was tesa® 4965. Prior to particle measurement, the frame is pushed together with the sample over the intake funnel of one of the two particle counters.

1. The use of a textile fabric which has at least one napped side for attachment in front of windows or doors to guard against dusty allergens such as pollen or house dust.

2. The use according to claim 1, wherein the fabric is a formed-loop knit.

3. The use according to claims 1 or 2, wherein the basis weight of the textile fabric is between 30 and 200 g/m², preferably between 40 and 100 g/m².

4. The use according to at least one of claims 1 to 3, wherein the filaments of the threads consist of polyesters, polyamides or polyolefins.

5. The use according to at least one of claims 1 to 4, wherein the diameter of the filaments of the threads is between 10 and 100 μm, preferably between 10 and 50 μm and more preferably between 10 and 25 μm.

6. The use according to at least one of claims 1 to 5, wherein the diameter of the threads is between 50 and 500 μm and preferably between 50 and 300 μm.

7. The use according to at least one of claims 1 to 6, wherein the course density is from 100 to 600 and preferably from 150 to 300 and the wale density is from 50 to 500 and more preferably from 100 to 300.

8. The use according to at least one of claims 1 to 7, wherein the textile fabric is a multithread system.

9. The use according to at least one of claims 1 to 8, wherein the warp threads are intermeshed in the form of a tricot construction.

10. The use according to at least one of claims 1 to 9, wherein the warp threads are intermeshed in the form of a plain cloth construction.

11. The use according to at least one of claims 1 to 10, wherein the warp threads are intermeshed in the form of a satin construction.

12. The use according to at least one of claims 1 to 11, wherein the warp threads are intermeshed in the form of a velvet construction.

13. A flyscreen comprising a textile fabric according to any one of claims 1 to 12.
